(19) United States
(12) Patent Application Publication
(10) Pub. No.: US 2018/0232858 A1
(43) Pub. Date: Aug. 16, 2018

(54) IMAGE COMPRESSION METHOD, IMAGE RECONSTRUCTION METHOD, IMAGE COMPRESSION DEVICE, IMAGE RECONSTRUCTION DEVICE, AND IMAGE COMPRESSION AND RECONSTRUCTION SYSTEM

(71) Applicant: BOE TECHNOLOGY GROUP CO., LTD., Beijing (CN)

(72) Inventor: Shihao WANG, Beijing (CN)

(73) Assignee: BOE TECHNOLOGY GROUP CO., LTD., Beijing (CN)

(21) Appl. No.: 15/512,440

(22) PCT Filed: Jul. 12, 2016
(86) PCT No.: PCT/CN2016/089727

§ 371 Date: Mar. 17, 2017

(30) Foreign Application Priority Data
Jan. 27, 2016 (CN) 201610057277.7

(51) Int. Cl. G06T 5/00; H04N 19/60; G06T 7/11; G06T 9/00

(52) U.S. Cl. CPC G06T 5/001; H04N 19/60; G06T 2207/20064; G06T 9/00; G06T 7/11

(57) ABSTRACT

The present disclosure provides an image compression method, an image reconstruction method, an image compression device, an image reconstruction device, and an image compression and reconstruction system. The image compression method includes dividing, by an image compression device, an image into a target region and a non-target region, sampling at a first sampling rate, by the image compression device, a first image signal at the target region, to acquire a first sample image, sampling at a second sampling rate smaller than or equal to the first sampling rate, by the image compression device, a second image signal at the non-target region, to acquire a second sample image, and transmitting, by the image compression device, the first sample image and the second sample image to an image reconstruction device, to enable the image reconstruction device to recover the image in accordance with the first sample image and the second sample image.

### CROSS-REFERENCE TO RELATED APPLICATION

The present application claims a priority of the Chinese Patent Application No. 201610057277.7 filed on Jan. 27, 2016, which is incorporated herein by reference in its entirety.

### TECHNICAL FIELD

The present disclosure relates to the field of display technology, in particular to an image compression method, an image reconstruction method, an image compression device, an image reconstruction device, and an image compression and reconstruction system.

### BACKGROUND

With the coming of the information age, image transmission has become an important communication way. Currently, due to the vast amounts of data for an image, during the image transmission, an image signal may be sampled at a suitable sampling rate and compressed at a suitable compression ratio (i.e., a ratio of a size of the image before the compression to a size of the image after the compression) based on Nyquist Sampling Theorem, and then the compressed image signal may be transmitted to a receiver. Upon the receipt of the compressed image signal, the receiver may use an image reconstruction method to recover the image in accordance with the compressed image signal.

During the image compression and image reconstruction, in order to reduce the transmission burden, it is necessary to increase the compression ratio during the compression of the image signal, and in order to recover the image as undistortedly as possible, it is necessary to increase the sampling rate during the sampling of the image signal. However, an increase in the sampling rate may inevitably lead to a decrease in the compression ratio. Hence, there is an urgent need to increase the compression ratio for the compression of the image signal while ensuring the image reconstruction quality.

### SUMMARY

An object of the present disclosure is to provide an image compression method, an image reconstruction method, an image compression device, an image reconstruction device, and an image compression and reconstruction system, so as to increase the compression ratio for the compression of the image signal while ensuring the image reconstruction quality.

In one aspect, the present disclosure provides in some embodiments an image compression method, including steps of: dividing, by an image compression device, an image into a target region and a non-target region; sampling at a first sampling rate, by the image compression device, a first image signal at the target region, so as to acquire a first sample image; sampling at a second sampling rate smaller than or equal to the first sampling rate, by the image compression device, a second image signal at the non-target region, so as to acquire a second sample image; and transmitting, by the image compression device, the first sample image and the second sample image to an image reconstruction device, so as to enable the image reconstruction device to recover the image in accordance with the first sample image and the second sample image.

In a possible embodiment of the present disclosure, subsequent to the step of dividing, by the image compression device, the image into the target region and the non-target region, the image compression method further includes performing, by the image compression device, sparsity transformation on the first image signal and the second image signal, so as to increase sparsity of the first image signal and the second image signal.

In a possible embodiment of the present disclosure, the step of sampling at the first sampling rate, by the image compression device, the first image signal at the target region so as to acquire the first sample image includes performing, by the image compression device, a compressed sensing (CS) operation on the first image signal at the target region at the first sampling rate, so as to acquire the first sample image, and the step of sampling at the second sampling rate, by the image compression device, the second image signal at the non-target region so as to acquire the second sample image includes performing, by the image compression device, a CS operation on the second image signal at the non-target region at the second sampling rate, so as to acquire the second sample image.

In a possible embodiment of the present disclosure, the step of performing, by the image compression device, the sparsity transformation on the first image signal and the second image signal includes: performing, by the image compression device, discrete wavelet transformation on the first image signal and the second image signal; and resetting, by the image compression device, the first image signal and the second image signal each having an amplitude smaller than a predetermined threshold to 0 after the discrete wavelet transformation.

In a possible embodiment of the present disclosure, the step of dividing, by the image compression device, the image into the target region and the non-target region includes dividing, by the image compression device, the image into the target region and the non-target region using an image division technology.

In a possible embodiment of the present disclosure, the step of dividing, by the image compression device, the image into the target region and the non-target region includes dividing, by the image compression device, the image into the target region and the non-target region in accordance with a pre-stored division rule, and the pre-stored division rule includes taking a human face in the image as the target region and taking the other region in the image as the non-target region.

In another aspect, the present disclosure provides in some embodiments an image reconstruction method, including steps of: receiving, by an image reconstruction device, a first sample image and a second sample image from an image compression device; recovering, by the image reconstruction device, the first sample image into a first image and the second sample image into a second image using a reconstruction algorithm; and fusing, by the image reconstruction device, the first image and the second image, so as to acquire an image before the compression.

In a possible embodiment of the present disclosure, the step of recovering, by the image reconstruction device, the first sample image into the first image and the second sample image into the second image using the reconstruction algorithm includes: recovering, by the image reconstruction device, the first sample image into the first image using an orthogonal matching pursuit (OMP) algorithm; and recovering, by the image reconstruction device, the second sample image into the second image using a stagewise orthogonal matching pursuit algorithm.

In a possible embodiment of the present disclosure, prior to the step of recovering, by the image reconstruction device, the first sample image into the first image using a first reconstruction algorithm and the second sample image into the second image using a second reconstruction algorithm, the image reconstruction method further includes resetting, by the image reconstruction device, an amplitude of a second image signal in the second sample image to 0, so as to increase the sparsity of the first sample image and the second sample image.

In yet another aspect, the present disclosure provides in some embodiments an image compression device, including: a division unit configured to divide an image into a target region and a non-target region; a compression unit configured to sample at a first sampling rate a first image signal at the target region so as to acquire a first ample image, and sample at a second sampling rate smaller than or equal to the first sampling rate a second image signal at the non-target region so as to acquire a second sample image; and a transmission unit configured to transmit the first sample image and the second sample image to an image reconstruction device, so as to enable the image reconstruction device to recover the image in accordance with the first sample image and the second sample image.

In a possible embodiment of the present disclosure, the image compression device further includes a transformation unit configured to perform sparsity transformation on the first image signal and the second image signal, so as to increase sparsity of the first image signal and the second image signal.

In a possible embodiment of the present disclosure, the compression unit is further configured to perform a CS operation on the first image signal at the target region at the first sampling rate so as to acquire the first sample image, and perform a CS operation on the second image signal at the non-target region at the second sampling rate so as to acquire the second sample image.

In a possible embodiment of the present disclosure, the transformation unit is further configured to perform discrete wavelet transformation on the first image signal and the second image signal, and reset the first image signal and the second image signal each having an amplitude smaller than a predetermined threshold to 0.

In a possible embodiment of the present disclosure, the division unit is further configured to divide the image into the target region and the non-target region using an image division technology.

In a possible embodiment of the present disclosure, the division unit is further configured to divide the image into the target region and the non-target region in accordance with a pre-stored division rule, and the pre-stored division rule includes taking a human face in the image as the target region and taking the other region in the image as the non-target region.

In still yet another aspect, the present disclosure provides in some embodiments an image reconstruction device, including: a reception unit configured to receive a first sample image and a second sample image from an image compression device; a reconstruction unit configured to recover the first sample image into a first image and the second sample image into a second image using a reconstruction algorithm; and a fusion unit configured to fuse the first image and the second image, so as to acquire an image before the compression.

In a possible embodiment of the present disclosure, the reconstruction unit is further configured to recover the first sample image into the first image using an orthogonal matching pursuit algorithm, and recover the second sample image into the second image using a stagewise orthogonal matching pursuit algorithm.

In a possible embodiment of the present disclosure, the image reconstruction device further includes a transformation unit configured to reset an amplitude of a second image signal in the second sample image to 0, so as to increase the sparsity of the first sample image and the second sample image.

In still yet another aspect, the present disclosure provides in some embodiments an image compression and reconstruction system including the above-mentioned image compression device and the above-mentioned image reconstruction device.

According to the image compression method, the image reconstruction method, the image compression device, the image reconstruction device and the image compression and reconstruction system in the embodiments of the present disclosure, the image compression device may divide the image into the target region and the non-target region, sample the first image signal at the target region at the first sampling rate to acquire the first sample image, and sample the second image signal at the non-target region at the second sampling rate smaller than the first sampling rate to acquire the second sample image, so as to increase a compression ratio for compressing the image at the non-target region. In addition, the image signal is sampled at a relatively high sampling rate at the target region, so it is able to recover the image at the target region as undistortedly as possible during the image reconstruction. In this way, in the case that the image at the target region contains an important content, it is able to increase the compression ratio during the image compression while ensure the reconstruction effect on the important image during the image construction, thereby to relieve the transmission burden.

### BRIEF DESCRIPTION OF THE DRAWINGS

FIG. 1 is a flow chart of an image compression method according to one embodiment of the present disclosure;

FIG. 2 is another flow chart of the image compression method according to one embodiment of the present disclosure;

FIG. 3 is a flow chart of an image reconstruction method according to one embodiment of the present disclosure;

FIG. 4 is a schematic view showing an image acquired by the image reconstruction method according to one embodiment of the present disclosure;

FIG. 5 is a schematic view showing an image acquired by a conventional image construction method;

FIG. 6 is another flow chart of the image reconstruction method according to one embodiment of the present disclosure;

FIG. 7 is a schematic view showing an image compression device according to one embodiment of the present disclosure;

FIG. 8 is another schematic view of the image compression device according to one embodiment of the present disclosure;

FIG. 9 is a schematic view showing an image reconstruction device according to one embodiment of the present disclosure;

FIG. 10 is another schematic view showing the image reconstruction device according to one embodiment of the present disclosure;

FIG. 11 is a schematic view showing a computer device according to one embodiment of the present disclosure; and

FIG. 12 is a schematic view showing an image compression and reconstruction system according to one embodiment of the present disclosure.

### DETAILED DESCRIPTION OF THE EMBODIMENTS

The present disclosure will be described hereinafter in a clear and complete manner in conjunction with the drawings and embodiments. Obviously, the following embodiments merely relate to a part of, rather than all of, the embodiments.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

For ease of understanding an image compression method and an image reconstruction method in the embodiments of the present disclosure, some concepts involved herein will be described at first.

“Image division” refers to a technique and process of dividing an image into several specific regions having unique properties and extracting a target of interest. Currently, an image division method mainly includes a threshold-based division method, a region-based division method, an edge-based division method and a specific theory-based division method.

For an identical image, a user's visual attention may be caused by different regions of the image in different degrees. In other words, usually a user may be interested in a certain portion of the image, e.g., a person in a picture. Hence, after the image division, it is able to divide the image into a target region and a non-target region, and the target region is a relatively important portion of the image.

“Compressed sensing (CS)”, also called as “compressive sampling” or “sparse sampling”, as a new sampling theory, refers to a technique of developing sparsity characteristics of a signal, acquiring a discrete sample of the signal through random sampling at a sampling rate far smaller than a Nyquist sampling rate to acquire a sample image, and then reconstructing the sample image through a nonlinear reconstruction algorithm.

“Sparsity” refers to a relative percentage of units of a multi-dimensional structure not containing any data, and it may be represented by the number of amplitudes which are non-zero elements in an image signal.

The present disclosure provides in some embodiments an image compression method which, as shown in FIG. 1, includes: Step 101 of dividing, by an image compression device, an image into a target region and a non-target region; Step 102 of sampling at a first sampling rate, by the image compression device, a first image signal at the target region, so as to acquire a first sample image; Step 103 of sampling at a second sampling rate smaller than or equal to the first sampling rate, by the image compression device, a second image signal at the non-target region, so as to acquire a second sample image; and Step 104 of transmitting, by the image compression device, the first sample image and the second sample image to an image reconstruction device, so as to enable the image reconstruction device to recover the image in accordance with the first sample image and the second sample image.

In Step 101, the image compression device may divide the image into the target region and the non-target region on the basis of an image division technique, e.g., the edge-based division method. The target region is a relatively important portion of the image.

Of course, the image compression device may also divide the image into the target region and the non-target region in accordance with a pre-stored division rule. For example, the pre-stored division rule may include taking a human face in the image as the target region, and taking the other region as the non-target region. The division rule may be set in accordance with the practical need, and thus will not be particularly defined herein.

In Step 102, the image compression device may sample the first image signal at the target region at the first sampling rate, so as to acquire the first sample image. In Step 103, the image compression device may sample the second image signal at the non-target region at the second sampling rate, so as to acquire the second image, and the second sampling rate is smaller than or equal to the first sampling rate.

In other words, because the target region is the relatively important portion of the entire image (i.e., the portion of interest), the first image signal at the target region may be sampled at the higher first sampling rate, so as to acquire the first sample image, thereby to enable the image reconstruction device to subsequently recover the image at the target region in a better manner.

Correspondingly, in order to improve a compression ratio during the image compression and reduce the system overhead during the image transmission, the second image signal at the non-target region may be sampled at the lower second sampling rate, so as to acquire the second sample image. In this way, it is able to acquire the image at the target region as undistortedly as possible, and increase the compression ratio during the entire image transmission.

To be specific, in Step 102 and Step 103, the image compression device may sample the first image signal and the second image signal based on Nyquist Sampling Theorem, and then acquire the compressed first sample image and second sample image through discrete cosine transformation and quantization.

In a possible embodiment of the present disclosure, based on the above-mentioned CS technique, the image compression device may further perform a CS operation on the first image signal at the target region at the first sampling rate so as to acquire the first sample image, and perform a CS operation on the second image signal at the non-target region at the second sampling rate so as to acquire the second sample image.

In a possible embodiment, during the CS operation, the larger the sparsity of the image signal, the better the compression effect. Hence, prior to the CS operation, the image compression device may further perform sparsity transformation on the first image signal and the second image signal, so as to increase sparsity of the first image signal and the second image signal.

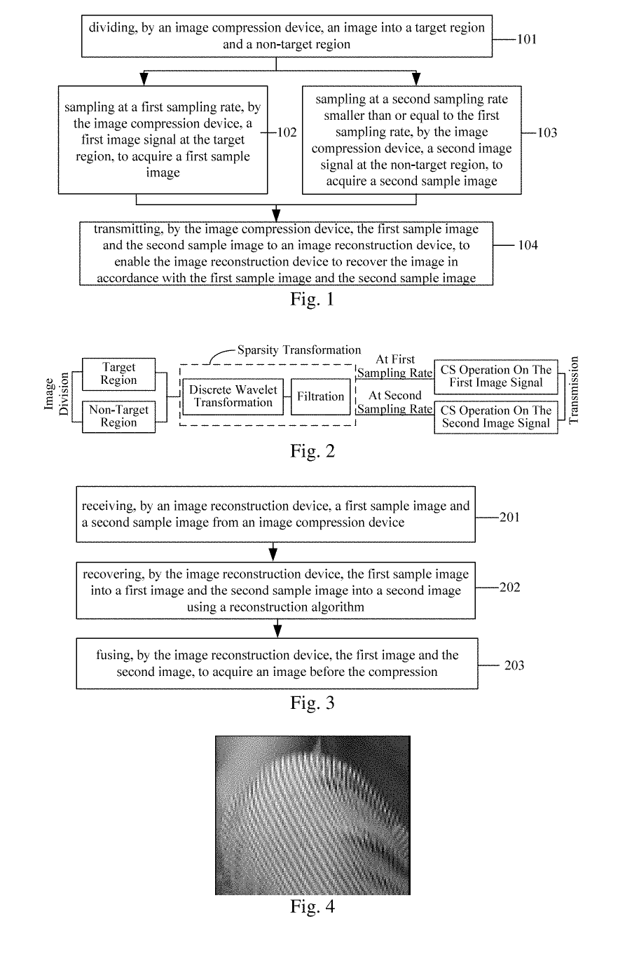

For example, as shown in FIG. 2, which is a schematic view showing an image compression procedure by the image compression device, after dividing the image into the target region and the non-target region, the image compression device may perform discrete wavelet transformation on the first image signal at the target region and the second image signal at the non-target region, and then filter out the first image signal and the second image signal with a suitable predetermined threshold, i.e., reset the first image signal and the second image signal each having an amplitude smaller than the predetermined threshold to 0, so as to increase the sparsity of the first image signal and the second image signal. Next, the image compression device may perform the CS operation on the first image signal at the target region at the first sampling rate so as to acquire the first sample image, and perform the CS operation on the second image signal at the non-target region at the second sampling rate so as to acquire the second sample image. At this time, the entire image compression has been completed.

In addition, there may exist a high frequency signal and a low frequency signal in the first image signal and the second image signal acquired after the sparsity transformation. The so-called high frequency signal usually relates to some details in the image, e.g., textures or patterns of the image. At this time, in the case that the second image signal includes the high frequency signal, the high frequency signal may also be sampled at a relatively high sampling rate (e.g., the first sampling rate), so as to ensure the image reconstruction quality.

In a possible embodiment of the present disclosure, in Step 104, the image compression device may transmit the first sample image and the second sample image acquired in Steps 102 and 103 to the image reconstruction image, and then the image reconstruction device may recover (i.e., reconstruct) the image in Step 101 in accordance with the first sample image and the second sample image. An image reconstruction method adopted by the image reconstruction device will be described hereinafter.

According to the image compression method in the embodiments of the present disclosure, the image compression device may divide the image into the target region and the non-target region, sample the first image signal at the target region at the first sampling rate to acquire the first sample image, and sample the second image signal at the non-target region at the second sampling rate smaller than the first sampling rate to acquire the second sample image, so as to increase a compression ratio for compressing the image at the non-target region. In addition, the image signal is sampled at a relatively high sampling rate at the target region, so it is able to recover the image at the target region as undistortedly as possible during the image reconstruction. In this way, in the case that the image at the target region contains an important content, it is able to increase the compression ratio during the image compression while ensure the reconstruction effect on the important image during the image construction, thereby to relieve the transmission burden.

The present disclosure further provides in some embodiments an image reconstruction method which, as shown in FIG. 3, includes: Step 201 of receiving, by an image reconstruction device, a first sample image and a second sample image from an image compression device; Step 202 of recovering, by the image reconstruction device, the first sample image into a first image and the second sample image into a second image using a reconstruction algorithm; and Step 203 of fusing, by the image reconstruction device, the first image and the second image, so as to acquire an image before the compression.

In Step 201, the image reconstruction device may receive the first sample image and the second sample image from the image compression device. The first sample image and the second sample image may be those acquired in the above-mentioned Steps 102 and 103, respectively.

Here, the first sample image and the second sample image may each be transmitted in the form of a digital signal.

In Step 202, the image reconstruction device may, using a reconstruction algorithm, recover the first sample image into the first image and recover the second sample image into the second image.

The image reconstruction procedure performed by the image reconstruction device may be considered as an inverse procedure of the image compression procedure. In a possible embodiment of the present disclosure, the image reconstruction device may recover the first sample image into the first image using a CS reconstruction algorithm (e.g., an orthogonal matching pursuit algorithm), and recover the second sample image into the second image using the same CS reconstruction algorithm. The first image corresponds to the image at the target region during the image compression, and the second image corresponds to the image at the non-target region during the image compression.

In order to further improve the quality of the reconstructed image, the first sample image may be recovered into the first image and the second sample image may be recover into the second image using different CS reconstruction algorithms.

Although being time-consuming, the orthogonal matching pursuit algorithm may be used to improve the accuracy. The first sample image corresponds to the target region of the original image, so the image reconstruction device may recover the first sample image into the first image using the orthogonal matching pursuit algorithm. However, for the second sample image corresponding to the non-target region in the original image, the image reconstruction device may recover the second sample image into the second image using a stagewise orthogonal matching pursuit algorithm which has a shorter recovery time.

In addition, during the CS reconstruction, the larger the sparsity of the image signal, and the better the reconstruction effect. Hence, prior to the CS reconstruction, the image reconstruction device may further reset an amplitude of the second image signal in the second sample image, i.e., the amplitude of the second image signal corresponding to the non-target region, to 0, so as to increase the sparsity of the first sample image and the second sample image.

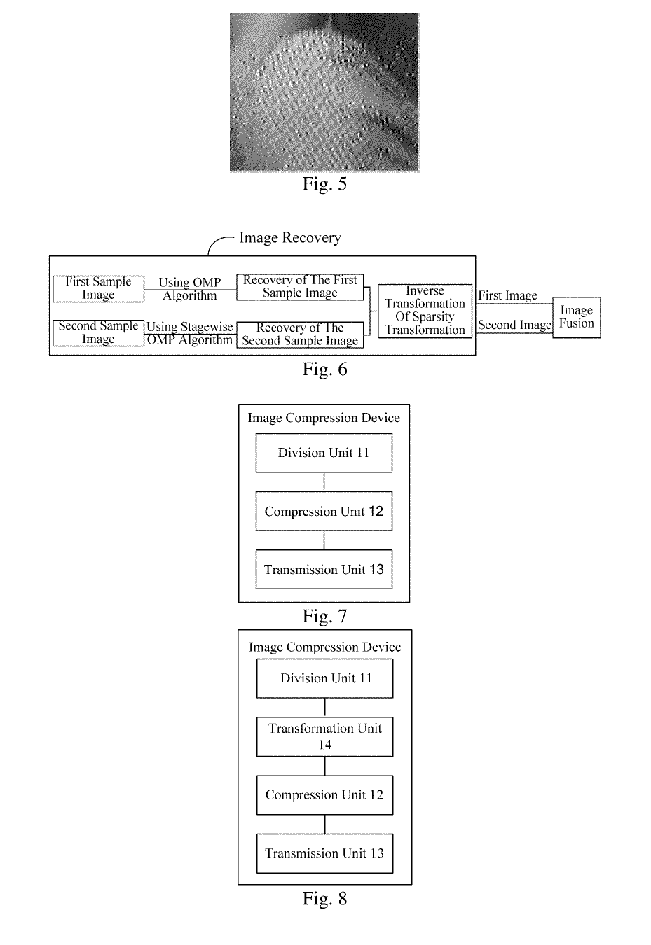

Taking the first image corresponding to the target region as an example, FIG. 4 shows the first image acquired by the image reconstruction method in the embodiments of the present disclosure, and FIG. 5 shows the first image acquired by the conventional image reconstruction method. It can be seen that, the image acquired by the image reconstruction method in the embodiments of the present disclosure may provide better image quality.

Finally, in Step 203, the image reconstruction device may fuse the first image and the second image based on an image fusion technique, so as to acquire the reconstructed image, thereby to recover the image before the compression.

As shown in FIG. 6, which shows the image reconstruction using the image reconstruction device, upon the receipt of the first sample image and the second sample image from the image compression device, the image reconstruction device may perform the CS reconstruction on the first sample image and the second sample image. To be specific, the image reconstruction device may recover the first sample image using the orthogonal matching pursuit algorithm, and recover the second sample image using the stagewise orthogonal matching pursuit algorithm, and then perform inverse transformation of the sparsity transformation, so as to acquire the reconstructed first image and second image. Next, it may fuse the first image and the second image through image fusion, so as to enable the reconstructed image after the image fusion to be identical to the image in the previous embodiment before the compression as possible.

According to the image reconstruction method in the embodiments of the present disclosure, upon the receipt of the first sample image and the second sample image from the image compression device, the image reconstruction device may recover the first sample image into the first image and recover the second sample image into the second image using the CS reconstruction algorithm. The first image may correspond to the image at the target region during the image compression, and the second image may correspond to the image at the non-target region during the image compression. Then, the image reconstruction device may fuse the first image and the second image, so as to acquire the image before the compression. It can be seen that, different compression policies are adopted for the target region and the non-target region during the image compression, so as to acquire the first image at the target region as undistortedly as possible during the image reconstruction. In this way, in the case that the image at the target region includes an important content, it is able to ensure the reconstruction quality of the important content during the image reconstruction and increase the compression ratio during the image compression, thereby to relieve the transmission burden.

The present disclosure further provides in some embodiments an image compression device which, as shown in FIG. 7, includes: a division unit 11 configured to divide an image into a target region and a non-target region; a compression unit 22 configured to sample at a first sampling rate a first image signal at the target region so as to acquire a first ample image, and sample at a second sampling rate smaller than or equal to the first sampling rate a second image signal at the non-target region so as to acquire a second sample image; and a transmission unit 13 configured to transmit the first sample image and the second sample image to an image reconstruction device, so as to enable the image reconstruction device to recover the image in accordance with the first sample image and the second sample image.

In a possible embodiment of the present disclosure, as shown in FIG. 8, the image compression device further includes a transformation unit 14 configured to perform sparsity transformation on the first image signal and the second image signal, so as to increase sparsity of the first image signal and the second image signal.

In a possible embodiment of the present disclosure, the compression unit 12 is further configured to perform a CS operation on the first image signal at the target region at the first sampling rate so as to acquire the first sample image, and perform a CS operation on the second image signal at the non-target region at the second sampling rate so as to acquire the second sample image.

In a possible embodiment of the present disclosure, the transformation unit 14 is further configured to perform discrete wavelet transformation on the first image signal and the second image signal, and reset the first image signal and the second image signal each having an amplitude smaller than a predetermined threshold to 0.

In a possible embodiment of the present disclosure, the division unit 11 is further configured to divide the image into the target region and the non-target region using an image division technology.

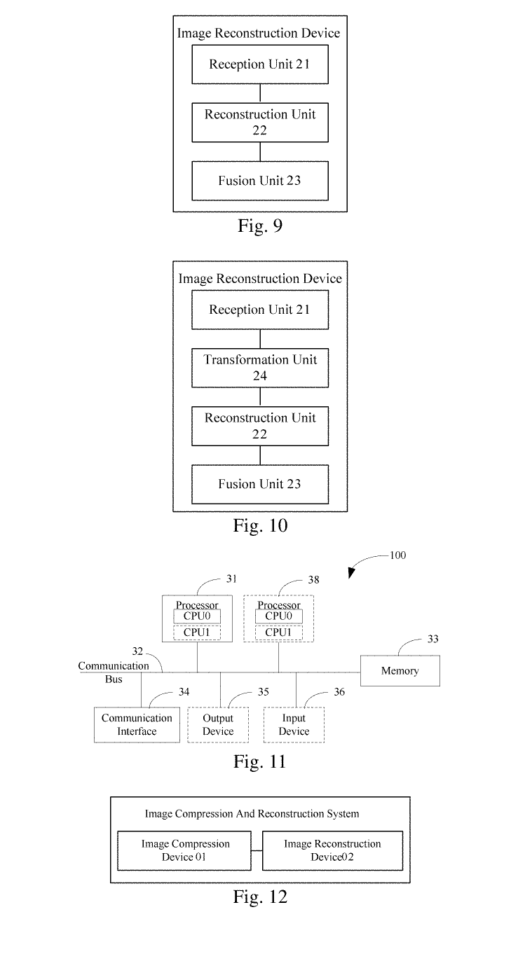

The present disclosure further provides in some embodiments an image reconstruction device which, as shown in FIG. 9, includes: a reception unit 21 configured to receive a first sample image and a second sample image from an image compression device; a reconstruction unit 22 configured to recover the first sample image into a first image and the second sample image into a second image using a reconstruction algorithm; and a fusion unit 23 configured to fuse the first image and the second image, so as to acquire an image before the compression.

In a possible embodiment of the present disclosure, the reconstruction unit 22 is further configured to recover the first sample image into the first image using an orthogonal matching pursuit algorithm, and recover the second sample image into the second image using a stagewise orthogonal matching pursuit algorithm.

In a possible embodiment of the present disclosure, as shown in FIG. 10, the image reconstruction device further includes a transformation unit 24 configured to reset an amplitude of a second image signal in the second sample image to 0, so as to increase the sparsity of the first sample image and the second sample image.

In addition, the image compression device and the image reconstruction device in FIGS. 7-10 may each be implemented by a computer device (or system) in FIG. 11.

As shown in FIG. 11, which is a schematic view showing the computer device according to one embodiment of the present disclosure, the computer device 100 includes at least one processor 31, a communication bus 32, a memory 33 and at least one communication interface 34.

The processor 31 may be a general-purpose central processing unit (CPU), a microprocessor, an application-specific integrated circuit (ASIC), or one or more integrated circuits for controlling the execution of programs.

The communication bus 32 may include a circuit for transmitting information among the above-mentioned components. The communication interface 34 may uses any device such as a receiver to communicate with any other device or communication network, e.g., Ethernet, Radio Access Network (RAN) or Wireless Local Area Network (WLAN).

The memory 33 may include, but not limited to, Read-Only Memory (ROM) or any other static memory capable of storing therein static information and instructions, Random Access Memory (RAM) or any other dynamic memory capable of storing therein information and instructions, Electrically Erasable Programmable Read-Only Memory (EEPROM), Compact Disc Read-Only Memory (CD-ROM), optical disc (compact disc, laser disc, digital general disc or blue-ray disc), magnetic disc or any other magnetic memory, or any other storage medium capable of carrying or storing therein instructions or desired program codes in a data form and capable of being accessed by a computer. The memory may be provided independently and connected to the processor via a bus. Of course, the memory may also be integrated with the processor.

The memory 33 is configured to store therein program codes for the execution of the schemes in the embodiments of the present disclosure, and the processor 31 is configured to execute the program codes stored in the memory 33.

In a possible embodiment of the present disclosure, the processor 31 may include one or more CUPs, e.g., CUP0 and CPU1 in FIG. 11.

In a possible embodiment of the present disclosure, the computer device 100 may include a plurality of processors, e.g., processor 31 and processor 38 in FIG. 11. Each of these processors may be a single-core CPU, or a multi-core CPU. The so-called processor may refer to one or more devices, circuits and/or processor units for processing the data (e.g., instructions).

In a possible embodiment of the present disclosure, the computer device 100 may further include an output device 35 and an input device 36. The output device 35 may communicate with the processor 31 and display the information in various ways. For example, the output device 35 may be a liquid crystal display (LCD), a light-emitting diode (LED) display device, a cathode ray tube (CRT) display device, or a projector. The input device 36 may communicate with the processor 31 and receive the data inputted by a user in various ways. For example, the input device 36 may be mouse, keyboard, touch panel or sensing device.

The computer device 100 may be a general-purpose computer device or a special-purpose computer. During the implementation, the computer device 100 may be a desktop computer, a portable computer, a network server, a Personal Digital Assistant (PDA), a mobile phone, a flat-panel computer, a wireless terminal device, a communication device, an embedded device or any device having a structure similar to that in FIG. 11. The types of the computer device 100 are not particularly defined herein.

In addition, the present disclosure provides in some embodiment an image compression and reconstruction system which, as shown in FIG. 12, includes an image compression device 01 and an image reconstruction device 02 capable of communicating with the image compression device 01. The image compression using the image compression device 01 and the image reconstruction using the image reconstruction device 02 may refer to the above-mentioned embodiments, and thus will not be particularly defined herein.

According to the image compression method, the image reconstruction method, the image compression device, the image reconstruction device and the image compression and reconstruction system in the embodiments of the present disclosure, the image compression device may divide the image into the target region and the non-target region, sample the first image signal at the target region at the first sampling rate to acquire the first sample image, and sample the second image signal at the non-target region at the second sampling rate smaller than the first sampling rate to acquire the second sample image, so as to increase a compression ratio for compressing the image at the non-target region. In addition, the image signal is sampled at a relatively high sampling rate at the target region, so it is able to recover the image at the target region as undistortedly as possible during the image reconstruction. In this way, in the case that the image at the target region contains an important content, it is able to increase the compression ratio during the image compression while ensure the reconstruction effect on the important image during the image construction, thereby to relieve the transmission burden.

In the embodiments of the present disclosure, the features, structures, materials or characteristics may be combined in any way.

The above are merely the preferred embodiments of the present disclosure. Obviously, a person skilled in the art may make further modifications and improvements without departing from the spirit of the present disclosure, and these modifications and improvements shall also fall within the scope of the present disclosure.

1. An image compression method, comprising steps of:
dividing, by an image compression device, an image into a target region and a non-target region;
sampling at a first sampling rate, by the image compression device, a first image signal at the target region, to acquire a first sample image;
sampling at a second sampling rate smaller than or equal to the first sampling rate, by the image compression device, a second image signal at the non-target region, to acquire a second sample image; and
transmitting, by the image compression device, the first sample image and the second sample image to an image reconstruction device, to enable the image reconstruction device to recover the image in accordance with the first sample image and the second sample image.

2. The image compression method according to claim 1, wherein subsequent to the step of dividing, by the image compression device, the image into the target region and the non-target region, the image compression method further comprises:
performing, by the image compression device, sparsity transformation on the first image signal and the second image signal, to increase sparsity of the first image signal and the second image signal.

3. The image compression method according to claim 2, wherein the step of sampling at the first sampling rate, by the image compression device, the first image signal at the target region to acquire the first sample image comprises:
performing, by the image compression device, a compressed sensing (CS) operation on the first image signal at the target region at the first sampling rate, to acquire the first sample image, and
the step of sampling at the second sampling rate, by the image compression device, the second image signal at the non-target region to acquire the second sample image comprises:
performing, by the image compression device, a CS operation on the second image signal at the non-target region at the second sampling rate, to acquire the second sample image.

4. The image compression method according to claim 2, wherein the step of performing, by the image compression device, the sparsity transformation on the first image signal and the second image signal comprises:
performing, by the image compression device, discrete wavelet transformation on the first image signal and the second image signal; and
resetting, by the image compression device, the first image signal and the second image signal each having an amplitude smaller than a predetermined threshold to 0 after the discrete wavelet transformation.

5. The image compression method according to any claim 1, wherein the step of dividing, by the image compression device, the image into the target region and the non-target region comprises:
dividing, by the image compression device, the image into the target region and the non-target region using an image division technology.

6. The image compression method according to claim 1, wherein the step of dividing, by the image compression device, the image into the target region and the non-target region comprises dividing, by the image compression device, the image into the target region and the non-target region in accordance with a pre-stored division rule, and
the pre-stored division rule comprises taking a human face in the image as the target region and taking the other region in the image as the non-target region.

7. An image reconstruction method, comprising steps of:
receiving, by an image reconstruction device, a first sample image and a second sample image from an image compression device;
recovering, by the image reconstruction device, the first sample image into a first image and the second sample image into a second image using a reconstruction algorithm; and
fusing, by the image reconstruction device, the first image and the second image, to acquire an image before the compression.

8. The image reconstruction method according to claim 7, wherein the step of recovering, by the image reconstruction device, the first sample image into the first image and the second sample image into the second image using the reconstruction algorithm comprises:
recovering, by the image reconstruction device, the first sample image into the first image using an orthogonal matching pursuit algorithm; and
recovering, by the image reconstruction device, the second sample image into the second image using a stagewise orthogonal matching pursuit algorithm.

9. The image reconstruction method according to claim 7, wherein prior to the step of recovering, by the image reconstruction device, the first sample image into the first image using a first reconstruction algorithm and the second sample image into the second image using a second reconstruction algorithm, the image reconstruction method further comprises resetting, by the image reconstruction device, an amplitude of a second image signal in the second sample image to 0, to increase the sparsity of the first sample image and the second sample image.

10. An image compression device, comprising:
a division unit configured to divide an image into a target region and a non-target region;
a compression unit configured to sample at a first sampling rate a first image signal at the target region to acquire a first ample image, and sample at a second sampling rate smaller than or equal to the first sampling rate a second image signal at the non-target region to acquire a second sample image; and
a transmission unit configured to transmit the first sample image and the second sample image to an image reconstruction device, to enable the image reconstruction device to recover the image in accordance with the first sample image and the second sample image.

11. The image compression device according to claim 10, further comprising a transformation unit configured to perform sparsity transformation on the first image signal and the second image signal, to increase sparsity of the first image signal and the second image signal.

12. The image compression device according to claim 11, wherein the compression unit is further configured to perform a compressed sensing (CS) operation on the first image signal at the target region at the first sampling rate to acquire the first sample image, and perform a CS operation on the second image signal at the non-target region at the second sampling rate to acquire the second sample image.

13. The image compression device according to claim 11, wherein the transformation unit is further configured to perform discrete wavelet transformation on the first image signal and the second image signal, and reset the first image signal and the second image signal each having an amplitude smaller than a predetermined threshold to 0.

14. The image compression device according to claim 10, wherein the division unit is further configured to divide the image into the target region and the non-target region using an image division technology.

15. The image compression device according to claim 10, wherein the division unit is further configured to divide the image into the target region and the non-target region in accordance with a pre-stored division rule, and the pre-stored division rule comprises taking a human face in the image as the target region and taking the other region in the image as the non-target region.

16. An image reconstruction device, comprising:
a reception unit configured to receive a first sample image and a second sample image from an image compression device;
a reconstruction unit configured to recover the first sample image into a first image and the second sample image into a second image using a reconstruction algorithm; and
a fusion unit configured to fuse the first image and the second image, to acquire an image before the compression.

17. The image reconstruction device according to claim 16, wherein the reconstruction unit is further configured to recover the first sample image into the first image using an orthogonal matching pursuit algorithm, and recover the second sample image into the second image using a stagewise orthogonal matching pursuit algorithm.

18. The image reconstruction device according to claim 16, further comprising a transformation unit configured to reset an amplitude of a second image signal in the second sample image to 0, to increase the sparsity of the first sample image and the second sample image.

19. An image compression and reconstruction system, comprising the image compression device according to claim 10, and an the image reconstruction device, wherein
the image reconstruction device, comprises: a reception unit configured to receive a first sample image and a second sample image from an image compression device; a reconstruction unit configured to recover the first sample image into a first image and the second sample image into a second image using a reconstruction algorithm; and a fusion unit configured to fuse the first image and the second image, to acquire an image before the compression.
